(19) United States
(12) Patent Application Publication
(10) Pub. No.: US 2020/0308374 A1
(43) Pub. Date: Oct. 1, 2020

(54) FIRE-RETARDING MIXTURE, PROCESS FOR PRODUCING THE MIXTURE, FABRIC TREATED WITH THE MIXTURE AND METHOD OF TREATING A FABRIC WITH THE MIXTURE

(71) Applicant: PROSETEX S.P.A., BULCIAGO (IT)

(72) Inventors: DAVIDE COLOMBO, BULCIAGO (IT); LUCA MAGAGNIN, BULCIAGO (IT); ALESSANDRA ACCOGLI, BULCIAGO (IT); EUGENIO GIBERTINI, BULCIAGO (IT)

(21) Appl. No.: 16/327,006

(22) PCT Filed: Aug. 28, 2017
(86) PCT No.: PCT/IB2017/055149

§ 371 Date: Feb. 21, 2019

(30) Foreign Application Priority Data
Aug. 30, 2016 (IT) 102016000087988
Aug. 30, 2016 (IT) 102016000088008

(51) Int. Cl. C08L 9/06; D06M 15/233; D06M 15/693; D06M 23/04; D06M 11/46; C08K 3/22; C08L 97/00; C08K 3/32; D06M 11/70

(52) U.S. Cl. CPC C08L 9/06; D06M 15/233; D06M 15/693; D06M 23/04; D06M 11/46; C08K 3/22; C08K 2201/005; C08K 3/32; D06M 11/70; D06M 2200/30; C08K 2003/2241; C08L 2201/02; C08K 2003/322; C08L 97/005

(57) ABSTRACT

A fire-retarding mixture made from a polymeric binder consisting of a butadiene-based latex, a titanium dioxide TiO₂ and an alkaline lignin.

The present invention relates to a fire-retarding mixture, a process for the production thereof, a fabric treated with this mixture and a method for treating a fabric with said mixture.

It is known in the technical sector of fabrics, in particular where the fabrics are used as a lining or covering, that the same are required by regulations to be fire-proof in order to ensure the safety of end users.

It is also known that all textile products by nature are inflammable and respond to the application of a flame in a completely different manner depending on the chemical nature of the fibres (cotton, nylon, propylene, viscose), their orientation inside the article, the physical dimensions and the end application.

Depending on the characteristics of the article, the fire behaviour is completely different: for example, the lower the ratio between mass and surface area of the material, the easier and the faster it will burn.

The combustion of the fabric is also influenced by its structure which determines the accessibility of oxygen/air, combustion agent of the combustion reaction.

The end application of the fabric influences significantly the fire-behaviour: in the case of fabrics used for furnishing, such as curtains and hung materials, the reaction is extremely critical, due to the heat flow which spreads upwards, the double exposure to the combustion agent (air/oxygen) and transportation of the flames which is facilitated. In the sector of the textile industry, the fire-proofing treatment of fabrics is based mainly on a process of back-coating with polymer resins which are subject to different phases during the combustion process.

In the case of polymer materials, combustion may be defined as being a catalytic exothermic reaction which is self-fuelling following the generation of free radicals, principally the species H. and OH., and radiant heat. The flame is an exothermic combustion in the gaseous phase and the heat generated increases the thermal degradation of the polymer material in the solid phase, causing the further emission of combustible vapours. The cycle is therefore self-fuelling and self-accelerating until the fabric has been completely burned.

Owing to their organic nature, it is not possible to develop polymers which do not burn: only the use of specific additives, known as flame-retarding agents, allows the combustibility and the speed of propagation of the flame to be reduced, resulting in some cases in a behaviour which is referred to as being “self-extinguishing”.

Flame-retardants are therefore chemical species which are designed to improve the fire-reaction of the polymer materials. Their main function is to reduce the speed of heat transfer to the polymer so as to prevent the thermal degradation process thereof, with the consequent formation of radical species which, being free, interrupt the self-fuelling cycle.

The method currently preferred for providing the polymer with an anti-flame behaviour consists in adding to a polymer resin flame-retarding additives of a varying nature.

From this point of view, the fire-resistance in the case of polymers may, in general, be improved principally by adopting three different strategies:
acting in the vapour phase where the flame retardants interact with the combustion reaction in the vapour phase,
acting in the condensed phase where the flame retardants prevent the degradation of the polymer and the diffusion of heat with the formation of combustion products;
adding flame retardants which facilitate the dispersion of the heat from the polymer, limiting the thermal degradation thereof and all the processes associated with it.

Currently the desired characteristics in terms of flame resistance are achieved by means of processes involving spreading the back of the fabric with polymer resins to which antimony trioxide (Sb₂O₃) is added, along with halogenated additives.

The toxicity and the environmental impact associated with antimony trioxide (Sb₂O₃) are such, however, that the use of this chemical substance must be restricted.

Further examples of the prior art are described in:

CN 104480735, which describes an imitation leather made of polyurethane (PU), with flame-proof properties formed by a foamed layer combined with a surface layer. The surface layer comprises an aqueous resin consisting of polyurethane (60-80% by weight), palygorskite powder (1-2% by weight), sodium powder (1-2% by weight), magnesium hydroxide (0.1-1% by weight), bone meal (4-8% by weight), bean powder (1-2% by weight), sodium sulphate (02-1% by weight), aluminium (0.5-1% by weight), titanium dioxide (0.5-1% by weight), trimer sodium phosphate (0.1-0.3% by weight), calcium lignin sulfonate (0.4-0.8% by weight), pigmenting cream (2-4% by weight) and further additive compounds.

CN102320782, which describes a fire-retarding paint comprising a binder consisting of a PVA-based emulsion, a rice husk ash and an alkaline activated meta-kaolinite homopolymer. Sodium lignin sulfonate and TiO2 (titanium white) may be added to the paint as auxiliary components.

JP 2002105335, which relates to a thermoplastic synthetic resin, namely a thermosetting synthetic polymer, which has intrinsic fire-proof properties owing to the addition of phosphorus and nitrogen containing compounds.

CN 105219221, which describes a water-based paint for walls, which, among a great number of different components, comprises: 0.27-0.29% by weight of styrene-butadiene latex; 0.08-0.11% by weight of lignocellulose, and 0.22-0.25% by weight of TiO₂ (titanium white).

U.S. Pat. No. 4,705,816 describes instead a water-based polymer compound which may be applied onto the ground by means of spraying and is able to form a protective crust which improves the production of crops. The polymer compound may comprise a styrene-butadiene latex and a filler which may consist of an organic material such as sawdust, cellulose, starch, lignin sulfonate, lignin or a vegetable material, or organic waste. No indication is given as to how to obtain a suitable mixture for fire-retarding treatment of materials such as fabrics.

The technical problem which is posed therefore is to provide fire-retarding products which are able to solve the problems of the prior art, being characterized by optimum flame-proof properties, low toxicity and easy disposability.

In connection with this problem it is also required that these products should be easy and low-cost to produce and be able to be applied to the fabrics using normal standardized processes.

Starting from these needs, the Applicant has surprisingly found that, by dispersing a sufficient quantity of titanium dioxide (TiO₂) and alkaline lignin in a water-based polymeric binder consisting of a butadiene-based latex, it is possible to obtain a polymeric mixture able to impart fire-retarding properties to the materials, such as fabrics, onto which it is applied.

By thermally treating a fabric onto which the polymeric mixture according to the invention has been applied beforehand, it is possible to obtain a fire-retarding layer thereon which prevents or at least slows down substantially the combustion of the fabric.

For the purposes of the present patent the term “fire-retarding” will be used to characterize a mixture with characteristics able to make a material, in the preferred case a fabric, fire-resistant or to limit the spreading of combustion in said material.

These results are obtained according to the present invention by a fire-retarding mixture according to the herein described subject matter.

The present invention relates furthermore to a process for the production of the mixture, and a fabric treated with the mixture according to the as well as a method of treating a fabric with the mixture according to the herein described subject matter.

Further details may be obtained from the following description of non-limiting examples of embodiment of the subject of the present invention, provided with reference to the accompanying drawings, in which:

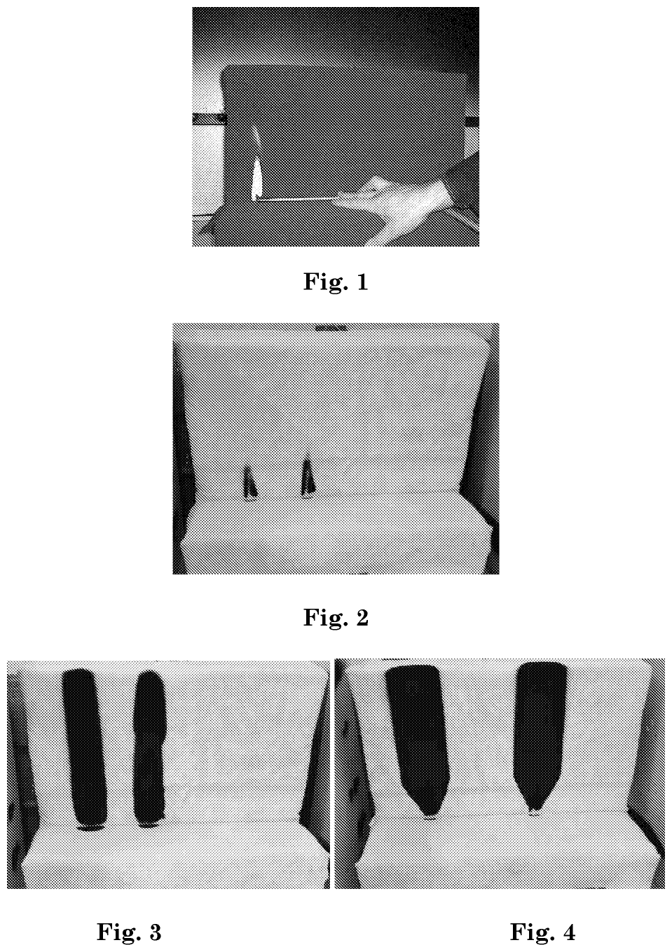

FIG. 1: shows a view of a seat lined with fabric and subjected to the action of a free flame;

FIG. 2: shows a view of a seat with fabric treated with a mixture according to the invention at the end of a test where a free flame is applied;

FIG. 3: shows a view of a seat lined with fabric treated with a fire-retarding product according to the prior art at the end of the test where a free flame is applied; and

FIG. 4: shows a view of a seat lined with untreated fabric at the end of the test where a free flame is applied.

In connection with the formulations of the mixture according to the invention a water-based polymeric emulsion is used, said emulsion also being known by the term latex or resin and consisting of a dispersion of a butadiene-based polymer in an aqueous medium; generally, the solid polymer part may be for example comprised between 40% and 60% by weight of the latex.

Butadiene-based latexes in the formulations of the present invention generally have an alkaline pH, generally of between 7 and 10, and preferably equal to about 8.

According to the invention, a fire-retarding mixture is provided, said mixture comprising:
a base component which is present in a quantity equal to at least 50% by weight of the mixture and consists of a water-based polymeric binder, in particular a butadiene-based latex;
Titanium dioxide (TiO₂), dispersed in the polymeric binder in a quantity at least equal to 4% by weight of the mixture;
Alkaline lignin, dispersed in the polymeric binder in a quantity at least equal to 4% by weight of the mixture.

Owing to the presence of at least 50% of polymeric binder consisting of a water-based latex, the mixture according to the invention will generally take the form of a polymeric dispersion with a varying degree of viscosity, i.e. generally liquid or paste-like, depending in particular on the quantity of alkaline lignin and TiO₂ dispersed in the polymeric binder.

The mixture may comprise a quantity by weight of butadiene-based latex preferably comprised between 50% and 92%, which may be chosen for example depending on the desired viscosity and the characteristics of the fabric to which the mixture is applied.

By way of a general example, greater quantities of alkaline lignin and/or TiO₂ will be particularly suitable with an increase in the weight per square metre of the fabric to be treated and/or in the percentage of synthetic, easily inflammable, material of the fabric to be treated. In the case of lightweight and natural fabrics instead, the mixture will be effectively formulated also for smaller quantities of the dispersed components.

In order to complete the composition of the mixture according to the invention, depending on the formulation requirements and/or viscosity and/or application requirements, one or more alkaline or neutral additive materials may be added, these being preferably chosen from among: water, an aqueous solution and/or an additional polymeric emulsion with compatible pH; at least one soaking agent (for example between 0.5% and 1% by weight of the mixture); at least one thickening agent (for example between 0.5 and 5% by weight of the mixture); at least one colouring agent, at least one foaming agent; at least one water-repelling additive; at least one additional flame-retarding agent in the liquid phase and/or in the solid phase.

For example, preferred embodiments of the mixture may comprise an ammonium phosphate compound, preferably in a quantity of between 0.1% and 25% by weight of the mixture, more preferably between 0.1% and 10% by weight. Preferred ammonium phosphate compounds are ammonium salts of phosphoric acid, preferably ammonium phosphate monobasic NH₄H₂PO₄ or ammonium hydrogen phosphate (NH₄)₂HPO₄.

The ammonium phosphate compound may be added in the solid phase, for example in the form of a powder obtained by means of mechanical grinding, with a particle size of between 50 nm and 800 micrometres, preferably between 100 nm and 500 micrometres. Preferably, however, the ammonium phosphate compound is added in the form of an aqueous solution of the ammonium phosphate compound, the concentration of which in solution is preferably between 25 and 600 grammes per litre of solution, and preferably less than or equal to 400 grammes per litre of solution.

The addition of these ammonium phosphate compounds may improve the fire-retarding capacity of the mixture, owing to the flame-proof properties of both phosphorus and nitrogen. The phosphorus compounds act both in the condensed phase and in the vapour phase when dispersed in polymeric solutions. The presence of nitrogen in NH₄ increases the fire-retarding characteristics of the phosphorus compounds and allows the release of gaseous nitrogen which dilutes the inflammable gases with a consequent reduction in the size of the flame.

Further preferred embodiments may comprise a carbonaceous component in the dispersed phase, chosen from one or more of the following carbon fillers: carbon nanotubes, graphene oxide, carbon black, expandable graphite, or combinations thereof. Preferably, the carbonaceous component which is dispersed has a particle size of between 10 nm and 1000 nm, and more preferably between 10 nm and 600 nm.

The addition of carbon nanotubes may allow a protective reticular structure to be obtained, this allowing a greater speed of release of the heat. Carbon black may help ensure effective thermal stabilization of the polymer which is induced by trapping of the free radicals produced by decomposition of the polymer matrix by the carbon black particles which form a reticular structure inside the polymer. Expandable graphite, obtained from crystalline graphite formed by planes of sp2 hybridized carbon atoms arranged, usually, in the form of a regular hexagonal lattice, helps improve considerably the fire-resistance characteristics of the polymers. In an example of preferred graphite the interplanar distance of the crystalline graphite is equal to 0.335 nm, while the interatomic distance between atoms in the same plane is 0.142 nm. Carbon fillers and in particular graphene oxide have the capacity to graphitize during combustion and form a “vitreous” layer or “char” layer; this layer is extremely compact, forming an optimum physical barrier, preventing propagation of the heat and transportation of material towards the combustion zone, limiting in fact propagation and further expansion of the flame.

By way of example, the mixture may comprise: carbon black in a quantity greater than or equal to 0.05% and preferably comprised between 0.3% and 4%, more preferably between 0.5% and 2.5% by weight of the mixture; and/or expandable graphite, the quantity of which is at least 0.01% by weight of the mixture and preferably between 0.05% and 3% by weight of the mixture; and/or carbon nanotubes, in a quantity at least equal to 0.01% by weight of the mixture, preferably comprised between 0.5% and 3% by weight of the mixture; and/or graphene oxide in a quantity equal to at least 0.01%, preferably between 0.1% and 2.5% by weight of the mixture.

The addition of the carbonaceous component will cause an increase in the viscosity of the polymeric dispersion according to the invention.

The Applicant has noticed an additional synergic fire-retarding effect when one or more of the aforementioned carbonaceous components in the dispersed phase is present in combination with an aqueous solution of an ammonium phosphate compound within a mixture according to the invention. These embodiments are therefore preferred and may be prepared for example by adding an aqueous solution of an ammonium phosphate compound with one or more carbonaceous components dispersed therein to the butadiene-based latex TiO₂ and lignin mixture.

Preferred embodiments of the mixture according to the invention may have a viscosity greater than about 2500 cPa, preferably greater than 3000 cPa, or even more preferably greater than 4000 cPa, in which cases the mixture is sufficiently viscose to be applied directly to the surface of a fabric to be treated, for example by means of back-coating.

According to another preferred embodiment, the mixture according to the invention may have instead a viscosity not greater than 2500 cPa; in this case it may be sprayed onto the fabric to be treated or the mixture may be foamed beforehand mechanically for application by means of (back) coating.

In any case, it is within the scope of the person skilled in the art to foam mechanically and/or add to a mixture according to the invention suitable agents from among those listed, so as to obtain a suitable viscosity and/or adapt it to the type of application required, in particular to an application by means of spreading or spraying over a surface, in particular of a fabric such as a fabric used for furnishing, for clothing, upholstery or for covering seats of vehicles or the like.

Preferably it is envisaged that the binder is a styrene-butadiene (SB) latex which also has non-fraying properties. These properties result in the additional advantageous effect that, once applied to the fabric, the preferred mixture will prevent fraying thereof.

According to preferred formulations of the invention the following are envisaged:
a quantity of TiO₂ comprised between 4% and 15%, preferably between 4% and 10%, by weight of the mixture; and/or
a quantity of alkaline lignin comprised between 4% and 15%, preferably between 4% and 10%, by weight of the mixture.

In the case of quantities of TiO₂ and alkaline lignin respectively less then 4%, the fire-retarding characteristics are insufficient.

The addition of quantities of TiO₂ or alkaline lignin greater than 15%. although possible, does not increase significantly the fire-retarding characteristics, representing in fact an unnecessary and uneconomical outlay on materials as well as resulting in a mixture which is more difficult to apply onto the fabric since it is extremely viscous.

The preferred ranges of between 4% and 10% are optimum if the mixture is to be foamed for application by means of back-coating.

The lignin is added to the butadiene-based latex, preferably consisting of SB resin, because it constitutes an extremely rich source of carbon which decomposes slowly in a wide temperature range (200-500° C.), producing volatile products, but also a condensed carbonaceous structure which forms an optimum physical barrier preventing propagation of the flame.

Furthermore, it consists of a low-cost ecological product, being one of the principal components of wood; it constitutes moreover one of the natural aromatic polymers most widely available in nature, having a good compatibility with butadiene-based latexes and in particular with SB resin (latex).

The alkaline lignin is chosen because, unlike similar products in the same family, such as lignin sulfonate, it has an alkaline pH and is not subject to polymer crosslinking induced by the pH once dispersed in an alkaline polymeric latex such as styrene-butadiene latex.

Alkaline lignin is available and may be freely purchased commercially or may be obtained by means of treatment of the lignin sulfonate in NaOH.

The titanium dioxide may be added to the polymeric latex in powder form, preferably with a nanometric particle size, namely at least 90% of the titanium dioxide dispersed in the polymeric latex will have particle dimensions comprised between 10 and 500 nanometres, preferably between 10 nm and 100 nm; being a ceramic material, the TiO₂ acts as a heat dispersant, limiting the thermal degradation of the polymer and preventing self-fuelling of the flame.

TiO₂ is, moreover, a biocompatible component with a low environmental impact, as well as a photocatalyst, i.e. capable of degrading organic and inorganic pollutants when activated by solar ultraviolet radiation.

These properties of the mixture impart ecological and antibacterial characteristics to the treated fabrics.

### EXAMPLES AND TEST DATA

### Example 1

In an example of embodiment of the mixture according to the invention, the following were used per 100 g of mixture:
83 g of SB latex with 46% solid polymer part and 54% liquid part;
8.5 kg of TiO₂ in powder form, with an average powder size of about 20 nm;
8.5 g of alkaline lignin with a pH of about 9.

A portion of 0.72 m² of VISTELLA NEW fabric (Mixture: VI81,CO16,PL3) intended for lining a seat (FIG. 1) was treated applying a quantity of mixture according to Example 1, equal to about 30% by weight of the weight of the fabric per square metre; said mixture being foamed beforehand mechanically to obtain a viscosity of about 3000 cPa and applied by means of the back-coating method. The thickness of the coating blade was fixed at 1.5 mm. After application, the fabric with mixture applied was subjected to a heat treatment at 150° C. for 2 minutes so as to form a compact polymeric layer on the back of the fabric.

The fabric was exposed for a period of 21 s to a flame fuelled with Butane 1950 (2.8 kPa output pressure and about 45 ml/min flowrate), similar to the flame produced by a match.

The burner pipe had approximate dimensions of 200 mm length, 6.5 mm internal diameter and 8 mm external diameter.

The height of the flame applied was about 35 mm. The blowtorch was arranged parallel to the point of intersection between backrest and sitting surface of the seat.

The fabric caught fire and, once the blowtorch was removed, the flame self-extinguished in 15 seconds.

Once extinguished, a burnt area of about 11.5 cm² was left.

### Example 2

The test was carried out using the same operating conditions as in Example 1, but after treating the seat with a self-extinguishing agent based on antimony trioxide according to the prior art (FIG. 2) distributed under the trade name CETAFLAM and applied in a similar manner to that described for Example 1.

The fabric caught fire and, once the blowtorch had been removed, it was necessary for the operator to intervene in order to extinguish the flame which, after 120 s, was still lit.

Once the flame had been extinguished, a burnt area of about 120 cm² was left.

### Example 3

The same test was carried out using the same operating conditions described in Example 1, but after treating the fabric of the seat with only an SB latex pre-foamed mechanically so as to obtain a viscosity of up to 3000 cPa and applied in a similar manner to that described for Example 1.

The fabric caught fire (FIG. 3) and, once the blowtorch had been removed, it was necessary for the operator to intervene in order to extinguish the flame which, after 120 s, was still lit.

Once the flame had been extinguished, a burnt area of about 196 cm² was left. This is consistent with what is known in the art regarding butadiene latexes, and in particular styrene-butadiene resin latexes, which are easily flammable.

### Example 4

### Aqueous, Foamable, Polymeric Dispersion

The mixture according to Example 4 is an aqueous, foamable, polymeric dispersion. In this example, a styrene-butadiene copolymer latex (SB latex) characterized by a viscosity of 1000-1500 cPa is used. The quantities indicated in Table 1 relate to the preparation of 10 kg of mixture according to the invention, together with the composition percentages.

TABLE 1
Composition percentages and weight of the materials
for the preparation of 10 kg of final product.

| Material | Weight (kg) | Composition (%) |
|---|---|---|
| SB Latex | 9 | 90 |
| TiO₂ | 0.5 | 5 |
| Alkaline lignin | 0.5 | 5 |

For preparation, 9 kg of SB latex are poured into a cylindrical container. A helical mixer is inserted inside the container, in the same way as performed in a conventional paint mixing process, and set to a rotational speed of between 20 rpm and 70 rpm, so as not to draw in an excessive amount of air. Once the mixer has been activated, 0.5 kg of alkaline lignin and 0.5 kg of titanium dioxide nanoparticles with an average size of between 10 nm and 50 nm are weighed. These operations are carried out in safe conditions, using an anti-dust breathing mask with filters suitable for eliminating the nanoparticles. The two powders are roughly mixed, with the aid of a spatula, until a homogenous mix is obtained. The powder mix is added a little at a time to the SB latex being stirred and, once all the powder has been added, the dispersion is stirred for a further 30 minutes. The polymeric dispersion thus characterized by a dark brown colour, an alkaline pH of about 8 and a viscosity of about 2000 cPa.

The product is foamed using a foaming machine until a product viscosity of between 2500 and 3000 cPa is obtained. The product is applied by means of back-coating of a natural fibre fabric (CANNETTONE CINIGLIA, CO:70% VI:30%) using a common film applicator. The blade of the film spreader is adjusted to a thickness of 2 mm and the fabric is kept taut during application of the product so as to obtain a uniform coating. Once the coating on the surface of the fabric has been obtained, the fabric is heat-treated so as to favour crosslinking of the polymer phase and evaporation of the solvent. The treated fabric is exposed to a temperature of 150° C. for a period of 5 minutes. Following treatment, the final product is in the form of a thin, brown-coloured, polymeric film with a weight not exceeding 30% by weight of the fabric.

Test Data

The flame resistance procedure is identical to that already described for the preceding examples.

The result of the flame-resistance test was positive, since upon removal of the blowtorch, the flame self-extinguished in less than 21 s. The burnt area at the end of the flame test was on average equal to about 18.5 cm².

### Example 5

### Spreadable, Flame-Retarding, Aqueous, Polymeric Dispersion

In this example a styrene-butadiene copolymer latex (SB latex) characterized by a viscosity of 1000-1500 cPa is used. The values provided relate to the preparation of 10 kg of final product and are indicated in Table 2 together with the composition percentages.

TABLE 2
Composition percentages and weight of the materials
for the preparation of 10 kg of final product.

| Material | Weight (kg) | Composition (%) |
|---|---|---|
| SB Latex | 7.5 | 75 |
| TiO₂ | 1.5 | 15 |
| Alkaline lignin | 0.8 | 8 |
| Wetting agent (KOLLASOL) | 0.07 | 0.7 |
| Water-repellent (ECOPERL ACTIVE) | 0.07 | 0.7 |
| Thickening agent (VERDICKER) | 0.06 | 0.6 |

For preparation of the mixture according to this example, the same procedure described for the preceding example is adopted, but during the mixing and homogenization phase, a soaking agent (Kollasol HV produced by CHT), a water-repelling additive and a polymeric thickening agent (TUBICOAT VERDICKER LP produced by CHT) are added. The polymeric dispersion obtained is characterized by a dark brown colour, an alkaline pH of about 8 and a viscosity of about 4500 cPa. The product is applied as such by means of back-coating on a fabric (UNI 124, VI:47% LI:23% PL:15% CO:15%) using a common film applicator. The blade of the film spreader is adjusted to a thickness of 1.5 mm and the fabric is kept taut during application of the product so as to obtain a uniform coating. Once the coating on the surface of the fabric has been obtained, the fabric is heat-treated so as to favour crosslinking of the polymer phase and evaporation of the solvent. The treated fabric is exposed to a temperature of 160° C. for a period of 5 minutes. Following treatment, the final product is in the form of a thin, brown-coloured, polymeric film with a weight not exceeding 30% by weight of the fabric.

Test Data

The flame test procedure is identical to that carried out for the preceding examples. Following removal of the blowtorch, the flame self-extinguished in less than 21 seconds and the burnt area left was equal on average to about 15 cm².

According to the invention, a process for the production of a fire-retarding mixture as described above is also provided, said process comprising the following steps:
preparing a quantity, greater than or equal to 50% by weight of the final mixture, of a polymeric binder consisting of a butadiene-based latex;
mixing the polymeric binder, for example by means of mechanical stirring (which may also involve light foaming);
adding TiO₂ in a quantity of at least 4% by weight of the final mixture and dispersion thereof in the binder being mixed;
adding alkaline lignin in a quantity of at least 4% by weight of the final mixture and dispersion thereof in the binder being mixed;
mixing the mixture, for example by means of stirring, for a period of at least 30 minutes, preferably a period of between 30 and 60 minutes.

Preferably the binder is a styrene-butadiene latex.

A preferred example of implementation of the production process may comprise the steps of:
preparing in a container the polymeric binder, preferably with a viscosity greater than or equal to 1000 cPa and preferably less than 2000 cPa, more preferably less than or equal to 1500 cPa.
stirring the polymeric binder inside the container, for example by means of operation of the mechanical mixer such as a helical mixer, at a rotational speed of between 10 rpm and 500 rpm, more preferably between 20 rpm and 70 rpm; these rotational speeds ensure that an excessive amount of air is not drawn in.
preparing alkaline lignin and particles of titanium dioxide, preferably with an average size of between 10 nm and 500 nm, more preferably between 10 nm and 100 nm.
mixing the particles of TiO₂ and lignin roughly until a uniform mix of powders is obtained;
gradual addition of the powder mix to the polymeric binder being stirred;
once the entire mix of powders has been added to the polymeric binder being stirred, continued mixing until a uniform polymeric dispersion is obtained, preferably at least for a further 30 minutes.

According to an embodiment, the mixture obtained is a polymeric dispersion with alkaline pH, for example comprised between 7 and 10 and preferably equal to about 8.

According to further embodiments, the mixture obtained may also have a viscosity greater than or equal to 2500 cPa, preferably greater than or equal to 3000 cPa, and even more preferably greater than 4000 cPa and/or be suitable for being applied to the surface of a fabric by means of spreading.

Preferably, and depending on the viscosity of the mixture obtained, the latter may be further treated with a foaming process which facilitates the applicability thereof to the fabrics by means of conventional industrial methods.

For example, according to preferred embodiments, the mixture obtained is a polymeric dispersion with a viscosity less than or equal to about 2500 cPa. Such a mixture is applicable by means of spraying, but is preferably foamed, for example using a foaming machine, until a viscosity of the mixture comprised between 2500-5000 cPa, and preferably comprised between 2500 and 3000 cPa, is obtained.

The foaming process may envisage the use of the stirred mixture contained inside a storage tank and supplied at room temperature to a foaming machine where the density values (g/l) and dispensing rate (preferably an average value of about 55 l/h) for the final product have been preset.

By means of a turbine system, the foaming machine mixes the mixture with a suitable quantity of air, producing the desired degree of foaming of the final product.

The mixture subjected to foaming may be easily applied to the fabric, in particular by means of conventional back-coating processes.

The present invention relates furthermore to a method for treating a fabric so as to obtain a fire-retarding article from a fabric base layer to which a fire-retarding mixture according to the invention has been applied.

The treatment method envisages the following steps:
applying a layer of mixture according to the invention to a surface of a fabric;
heat-treatment of the fabric with the applied mixture at a temperature higher than 100° C. and preferably lower than 180° C.; the heat-treatment causes crosslinking of the polymeric phase of the mixture with formation on the treated surface of a fire-retarding layer consisting of a butadiene-based polymeric matrix in which TiO₂ and alkaline lignin are dispersed.

Preferably the mixture applied to the fabric is foamed beforehand; foaming is particularly preferred if the mixture has a viscosity less than or equal to 2500 cPa.

The foamed or non-foamed mixture is preferably applied by means of back-coating onto the rear of a fabric using a film applicator. The blade of the film spreader is adjusted to a thickness of at least 0.1 mm, preferably comprised between 0.1 and 3 mm, more preferably between about 1.5 and 2.5 mm, so as to obtain a corresponding thickness of the mixture layer applied; preferably the fabric is kept taut during application of the product so as to obtain a uniform coating.

Once a coating of the mixture according to the invention has been applied onto the surface of the fabric, the fabric is heat-treated so as to favour crosslinking of the polymeric phase and evaporation of any solvent. The treated fabric is exposed to a temperature higher than 100° C. and preferably less than 180° C., more preferably comprised between 140 and 160° C., for a period of 1-10 minutes, preferably between 3 and 6 minutes.

During this step the thickness of the mixture layer applied may become smaller.

Following the heat treatment, the final product is therefore a fabric with a fireproof layer on one of its surfaces, consisting of a thin polymeric film, with a generally brown colour, comprising a butadiene-based polymer matrix within which titanium dioxide TiO₂ and alkaline lignin are dispersed.

Preferably, the fire-retarding layer obtained has a thickness of at least 0.05 mm, preferably comprised between 0.1 mm and 3 mm, preferably less than or equal to 2.5 mm.

The weight of the fire-retarding layer obtained is preferably less than 70% of the weight of the treated fabric per square metre, generally between 10% and 70%, more preferably between 20% and 40%, of the weight of the treated fabric per square metre.

It is therefore clear how the mixture according to the invention has an optimum fire-retarding efficiency, is ecological and easily applied on an industrial level.

Although described in connection with a number of embodiments and a number of preferred examples of implementation of the invention, it is understood that the scope of protection of the present patent is determined solely by the claims below.

1-19. (canceled)

20. Fire-retarding polymeric mixture, comprising:
a water-based polymeric binder consisting of a butadiene-based latex, in a quantity of at least 50% by weight of the mixture;
titanium dioxide (TiO₂), dispersed in the polymeric binder, in a quantity of at least 4% by weight of the mixture;
alkaline lignin, dispersed in the polymeric binder, in a quantity at least equal to 4% by weight of the mixture.

21. Mixture according to claim 20, characterized in that the binder is a styrene-butadiene latex.

22. Mixture according to claim 20, characterized in that it comprises:
a quantity of TiO₂ less than or equal to 15%, preferably comprised between 4% and 10% by weight of the mixture; and/or
a quantity of alkaline lignin less than or equal to 15%, preferably comprised between 4% and 10%, by weight of the mixture.

23. Mixture according to claim 20, further comprising a carbonaceous component in the dispersed phase, chosen from: carbon nanotubes, graphene oxide, carbon black, expandable graphite, or a combination thereof.

24. Mixture according to claim 20, further comprising an ammonium phosphate compound in powder form or in aqueous solution.

25. Mixture according to claim 24, wherein the ammonium phosphate compound is an ammonium salt of phosphoric acid, preferably chosen from ammonium phosphate monobasic NH₄H₂PO₄ or ammonium hydrogen phosphate (NH₄)₂HPO₄.

26. Mixture according to claim 20, characterized in that it is foamed and/or sprayable and/or spreadable.

27. Mixture according to claim 20, characterized in that at least 90% of the titanium dioxide dispersed in the polymeric latex has particle dimensions comprised between 10 and 500 nanometres, preferably between 10 nm and 100 nm.

28. Use of a mixture according to claim 20 for the fire-retarding treatment of fabrics.

29. Process for the production of a Fire retarding mixture comprising:
a water-based polymeric binder consisting of a butadiene-based latex, in a quantity of at least 50% by weight of the mixture;
titanium dioxide (TiO₂), dispersed in the polymeric binder, in a quantity of at least 4% by weight of the mixture;
alkaline lignin, dispersed in the polymeric binder, in a quantity at least equal to 4% by weight of the mixture,
wherein the process comprises the following steps:
preparing a quantity, equal to at least 50% by weight of the mixture to be produced, of a water-based polymeric binder consisting of a butadiene-based latex;
adding titanium dioxide TiO₂ in a quantity equal to at least 4% by weight of the mixture to be produced and dispersion thereof in the binder;
adding alkaline lignin in a quantity equal to at least 4% by weight of the mixture to be produced and dispersion thereof in the binder;
optionally, adding alkaline or neutral additives;
mixing for a period of between 30 minutes and 60 minutes with formation of the mixture.

30. Process according to claim 29, characterized in that it comprises a further step of foaming the mixture following the mixing step.

31. Process according to claim 30, wherein at least 90% of the titanium dioxide dispersed in the polymeric latex has particle dimensions comprised between 10 and 500 nanometres, preferably between 10 nm and 100 nm.

32. Fabric comprising a fire-retarding layer composed of a butadiene-based polymeric matrix having, dispersed therein, titanium dioxide TiO₂ and alkaline lignin, obtainable by means of heat treatment of a layer of fire-retarding mixture according to claim 20 applied onto a surface of the fabric.

33. Fabric according to claim 32, characterized in that the fire-retarding layer has a thickness of at least 0.05 mm, preferably comprised between 0.1 and 3 mm, more preferably comprised between 0.1 and 2.5 mm.

34. Fabric according to claim 32 , wherein the fire-retarding layer has a weight less than 70%, preferably between 10% and 70%, more preferably between 25% and 40%, relative to the weight per square metre of the fabric.

35. Method for the fire-retarding treatment of a fabric, characterized in that it comprises a step of applying to the fabric a mixture according to a claim 20; and a step involving heat treatment of the fabric with mixture applied at a temperature higher than 100° C.

36. Method according to claim 35, wherein the mixture is applied by means of spreading or spraying on a surface of the fabric.

37. Method according to claim 35, wherein the heat treatment is performed at a temperature of less than 180° C., preferably comprised between 120° C. and 160° C.

38. Method according to claim 35, wherein a layer of mixture with a thickness of at least 0.1 mm, preferably between 1 and 4 mm, more preferably between 1.5 and 2.5 mm, is applied onto the surface of the fabric.
